(19) United States
(12) Patent Application Publication
(10) Pub. No.: US 2020/0326522 A1
(43) Pub. Date: Oct. 15, 2020

(54) Methods for clearing, mounting, and preserving specimens used in optical microscopy

(71) Applicant: Hempstead Halide, Inc., Galviston, TX (US)

(72) Inventor: Thomas E. Hays, Galviston, TX (US)

(21) Appl. No.: 16/379,658

(22) Filed: Apr. 9, 2019

(51) Int. Cl. G02B 21/34; G01N 1/30

(52) U.S. Cl. CPC G02B 21/34; G01N 1/34; G01N 1/30

(57) ABSTRACT

Disclose a new type of mounting solution, related formulations, and related methodologies.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of substances and related methodologies for clearing the microscopic structures of biological specimens for better resolution in optical microscopy. The disclosed subject matter is also in the field of applied chemistry.

Chemical Listing

Camphor—1,7,7-trimethylbicyslo(2.2.1)heptan-2-one (a.k.a. Bornan-2-one); Case No. 76-22-2; EC No. 200-945-0; PubChem No. 2537. Molecular formula C₁₀H₁₆O. Melting point: 175° C. (347° F.) Boiling point: 97.8° C. (208° F.) at sea level;
Chloral (anhydrous)—Trichloroacetaldehyde (a.k.a. Trichloroethanal); CAS No. 75-87-6; EC No. 200-911-5; PubChem No. 6407. Molecular formula C₂HC1₃O. Melting point: −57.5° C. (−71.5° F.) Boiling point: 209° C. (408° F.) at sea level. Index of refraction: 1.45572 at 20° C. (68° F.);
Copal—An aromatic tree resin from the trees Protium copal of North and South America and Hymenaea verrucose of East Africa;
Eucalyptol—1,3,3-trimethyl-2-oxabicyco[2.2.2)octane (a.k.a. 1,8-Cineole); CAS No. 470-82-6; EC No. 207-431-5; PubChem No. 2758. Molecular formula: C₁₀H₁₈O. Melting point: 2.9° C. (37.2° F.) Boiling point: 176° C. (349 F) at sea level;
Gum Arabic—A resin collected from species of acacia trees, primarily Acacia senegal and Vachellia seyal, native to the Sahel of Africa; Paraldehyde—2,4,6-trimethyl-1,2,5-trioxane; CAS No. 123-63-7; EC No. 204-639-8; PubChem No. 31264. Molecular formula: C₆H₁₂O₃. Melting point: 12.6° C. (54.7° F.) Boiling point: 127.8° C. (262° F.) at sea level. Index of refraction: 1.4049 at 20° C. (68° F.);
Sandarac—A resin obtained from the tree Tetraclinis articulate and similar cypress-like trees native to northwest Africa.

### BACKGROUND OF THE INVENTION

“Optical microscopy” is the art of using visible light and a system of lenses to magnify images of specimens or parts of specimens that cannot be seen by the naked eye. A microscope is an important tool in this art. In a typical mode of use, a biological specimen to be viewed is “mounted” on a “microscope slide” and placed under a series of lenses so that the specimen is magnified for viewing through the microscope. Usually, the slide is defined by a thin sheet of “crown glass” (a type of glass with an index of refraction equaling 1.50) or similar inert transparent material upon which a specimen may be place for observation through the microscope. Once a slide is mounted with a specimen, a light source is provided under and shown through the microscope slide to assist in viewing or observation of the magnified specimen.

FIG. 1 is an exploded view of a typical microscope slide 1000 for observing a specimen 2000. As shown in the figure, it is a common practice (e.g., in the field of microscopy and related fields including but not limited to entomology, histology and the like), when mounting a specimen 2000 to be examined upon a glass microscope slide 1000 to cover the mounted specimen with a thin flat cover of transparent glass, called a “cover glass” or “cover slip” 3000.

In view of the foregoing, “Mounting” is a term of art in optical microscopy that means to preserve and protect a biological specimen by placing it on the microscope slide and covering it with a non-perishable liquid mounting medium. “Preserving (preservation)” as used in microscopy, is a process, usually chemical in nature, for sterilizing biological specimens to prevent contamination and degradation from microbes and external environmental factors. Typically, the mounting medium dries and adheres to both the microscope slide and the specimen thereby anchoring the specimen to the slide and preserves the specimen by forming a protective layer over the specimen against contamination and degradation. A cover slip can also be placed over and adhered to the mounting medium in certain circumstances. The need for various types of “mounting mediums” is therefore apparent.

FIG. 2 is a diagram for loading a microscope slide 1000 with a specimen 2000. In a typical slide-loading process: (A.) a mounting medium 2010 may be placed on the slide 1000; (B.) the specimen 2000 may be provided and adjusted to the center of the slide 1000 (suitably, the mounting medium may be placed on the specimen after it has been placed on the slide rather than before); (C.) the glass cover 3000 may be placed over both of the specimen 2100 (typically at a tilted approach so that face of the cover 3000 engages the specimen 2000) and the mounting medium 2010; and (D.) the glass cover 3000 is lowered over the specimen in a way that prevents the trapping of air-bubbles in the mounting medium at the interface of the cover 3000 and specimen.

Various types of mounting mediums already exist. For instance, mixtures of eucalyptol (25-50% w/w (w/w, in respect of percentages, is a symbol indicating the particular percentage referred to was derived by dividing the weight of the component in issue by the weight of the entire composition of which it is a part)), paraldehyde (10-25% w/w) and camphor (10-20% w/w) with or without sandarac (5% w/w) are well known in the relevant art as mounting mediums for clearing, mounting and preserving biological specimens. Halliday, R. B., “Microscope Slide Mounting Media Results of Informal Survey,” Archives of Acarology List (rev'd, 15 Jun. 1994); see also Roth, “Safety Data Sheet—Euparal for Microscopy,” (16 Dec. 2016). As a controlled substance under United States law paraldehyde is both difficult to obtain and inconvenient to maintain in storage. Controlled Substances Act, Title 21 U.S.C. Ch. 13 § 801 et seq, Schedule IV. Unfortunately, this well-known mixture for mounting mediums are typically prepared outside of the United States of America because paraldehyde is heavily regulated as a “Controlled Substance” under U.S. laws. Id. Thus, a need exits for alternative types of mounting mediums that do not involve ingredients that are as heavily regulated as ingredients for the well-known mounting medium mixtures.

Another consideration in the use of mounting mediums is the combined index of refraction produced by light passing through an arrangement of microscope slide, specimen, mounting medium and coverslip. A combined index of refraction approaching 1.5, is desirable. A refraction index of 1.5 minimizes distortion of the image of the specimen when viewed directly through an optical microscope or indirectly as a photograph taken through an optical microscope. Paraldehyde has an index of refraction of 1.409. Therefore, the index of refraction for varieties of well-known mounting mediums are largely determined by the index of refraction of the paraldehyde in the mixture. So, a need further exists for mounting mediums that have a refractive index closer to 1.5 than 1.409.

### SUMMARY OF THE INVENTION

In view of the foregoing, an object of this specification is to disclose a new type of mounting solution, operative formulations, and related methodologies. In one preferred embodiment, the mounting solution may be a mixture of:

anhydrous chloral in a concentration range of about twenty-five to forty-seven percent (25-47%) by weight;
Eucalyptol in concentrations in a range of about thirty and fifty percent (30-50%) by weight;
camphor in concentrations in a range of about twenty and twenty-one percent (20-21%) by weight; and,
with or without sandarac or another resin such as gum Arabic or copal in a concentration of up to five percent (5%) by weight.

Suitably, the mixture serves as an improved mounting medium and clearing solution for biological specimens. In use the mounting mixture suitably preserves a specimen and presents the specimen for viewing as well as or better than known formulations of Euparal containing paraldehyde. Chloral is not a controlled substance under United States federal law. Substituting anhydrous chloral with an index of refraction of 1.456 in place of paraldehyde improves the combined index of refraction of a specimen mounted on a microscope slide utilizing the mounting solution mixture and covered by a glass coverslip. Consequently, it drastically improves the clarity of the image of the specimen when viewed directly through an optical microscope or indirectly as a photographic image taken through an optical microscope.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is an exploded view of a typical microscope slide 1000 for observing a specimen 2000;

FIG. 2 is a diagram of a mounting process;

FIG. 3 is a magnified photographic image of an unmounted specimen; and,

FIG. 4 is a magnified photographic image of a specimen mounted with an industry standard mounting medium; and,

FIG. 5 is a magnified photographic image of a specimen mounted with a medium of the present specification.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclose a new type of mounting solution. Suitably, the mixture serves as an improved mounting medium and clearing solution for biological specimens. In one preferred embodiment, the mounting solution may be a mixture of: anhydrous chloral in a concentration in a range of about twenty-five to forty-seven percent (25-47%) by weight; Eucalyptol in concentrations in a range of about thirty and fifty percent (30-50%) by weight; camphor in concentrations in a range of about twenty and twenty-one percent (20-21%) by weight; and, with or without sandarac or another resin such as gum Arabic or copal in a concentration of up to five percent (5%) by weight. In a preferred embodiment, the mixture is made by preparing a liquid mixture of anhydrous chloral with Eucalyptol and camphor with or without sandarac, gum Arabic, or copal in the weight percentages stated above.

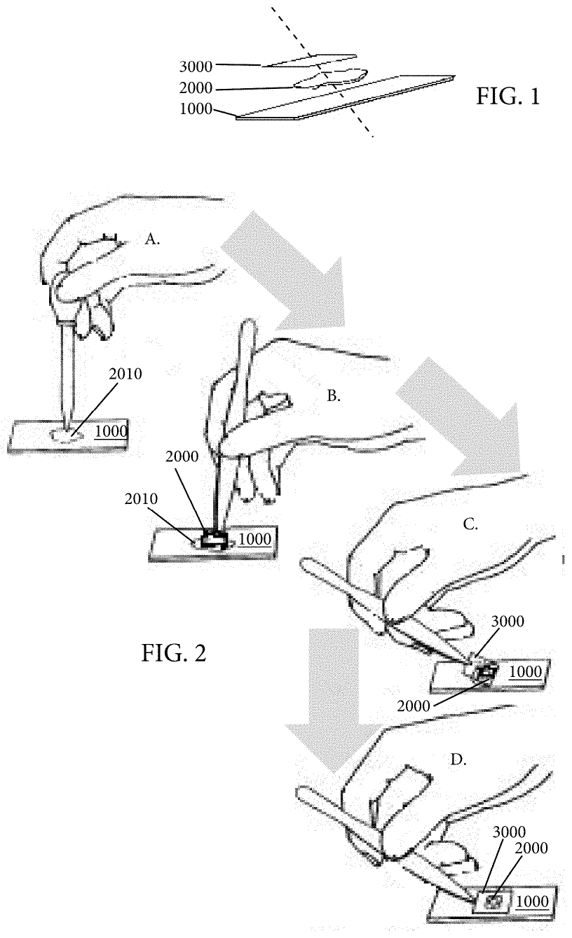

FIG. 2 shows a typical application of the disclosed mounting medium 2010. In use, medium 2010 may be applied by placing a specimen 2000 on a microscope slide and covering it with a liquid mounting medium mixture 2010 prepared according to the invention. To cover the specimen, the mounting medium may be first placed on the slide and the specimen submerged in the medium, as shown. Alternatively, the specimen may be first placed on the slide and the mounting medium placed over the specimen. Once covered, the cover slip 3000 may be placed over both the specimen 2000 and the mounting medium 2010. Suitably, the cover slip 3000 should be placed over the specimen 2000 and liquid mounting medium mixture 2010 in an orientation that is parallel to the plane of the glass microscope slide 1000. The specimen 2000 may then be viewed through a microscope directly or indirectly (e.g., as a photographic image). A glass coverslip may or may not be used.

### Example 1

As an example of the invention and not by way of limitation a liquid mixture is prepared according to the invention by mixing together thirty (30) grams of eucalyptol, twenty-five (25) grams of anhydrous chloral, twenty (20) grams of camphor and five (5) grams of sandarac. Referring to FIG. 2, a thin section of a biological specimen 2000 is placed on a microscope slide 1000 (A.-B.), covered with the liquid mixture 2010 (A.-B.) and then covered with a glass coverslip 3000 (C.). The microscope slide 1000, specimen 2000, liquid mixture 2010 and coverslip 3000 together are heated to a temperature of seventy degrees centigrade (70° C., 158° F.) and maintained at that temperature for twenty (20) minutes, after which time the microscope slide, specimen, liquid mixture, and cover glass together are removed from the heat source and allowed to cool. The specimen mounted on the microscope slide with the liquid mixture and coverslip together are viewed through an optical microscope.

### Example 2

As a second example of the invention and not by way of limitation, a liquid mixture is prepared according to the invention by mixing together thirty-two (32) grams of eucalyptol, forty-seven (47) grams of anhydrous chloral, and twenty-one (21) grams of camphor. A thin section of a biological specimen is placed on a microscope slide, covered with the liquid mixture and then covered with a glass coverslip. The microscope slide, specimen, liquid mixture and coverslip together are left to dry at room temperature for five days, after which time the microscope slide, specimen, liquid mixture, and glass coverslip together are viewed through an optical microscope.

### Example 3

As a third example of the invention and not by way of limitation, a liquid mixture is prepared according to the invention by mixing together forty (40) grams of eucalyptol, thirty-five (35) grams of anhydrous chloral, twenty (20) grams of camphor and five (5) grams of sandarac. A thin section of a biological specimen is placed on a microscope slide, covered with the liquid mixture and then covered with a glass coverslip. The microscope slide, specimen, liquid mixture and coverslip together are viewed through an optical microscope.

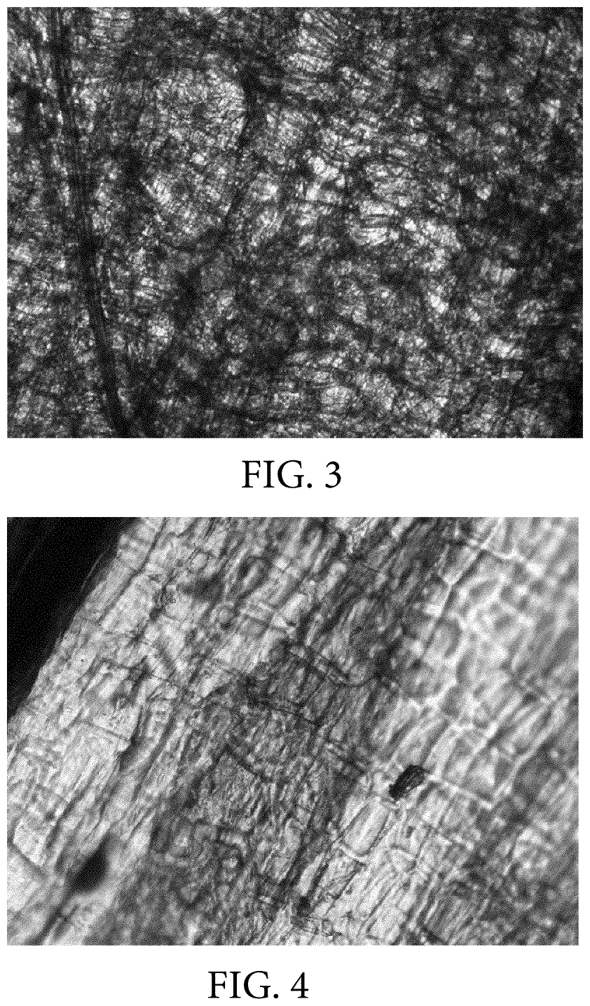

Suitably, two liquid mixtures were prepared. The first mixture was prepared according to the art. Specifically, the first mixture included thirty percent (30%) eucalyptol, forty-five (45%) percent paraldehyde, twenty percent (20%) camphor, and five percent (5%) sandarac. The second mixture was prepared according to the methods disclosed above. The second mixture therefore included thirty percent (30%) eucalyptol, forty-five percent (45%) anhydrous chloral, twenty percent (20%) camphor and five percent (5%) sandarac. In addition to the two mixtures, 6.3 mm (0.25″) diameter specimens were prepared from the outermost layer of one Allium cepa. FIGS. 3 through 5 are respectively (i) a photographic view of a specimen viewed through a microscope without any mounting medium, (ii) a photographic view of a specimen viewed through a microscope with the first mounting medium prepared above, and (iii) a photographic view of a specimen viewed through a microscope with the second mounting medium prepared above. As used here, the term “photographic view” refers to a photograph taken by an AmScope MD500 microscope eyepiece camera through a Brunel (UK) monocular optical microscope at 10/0.25 magnification.

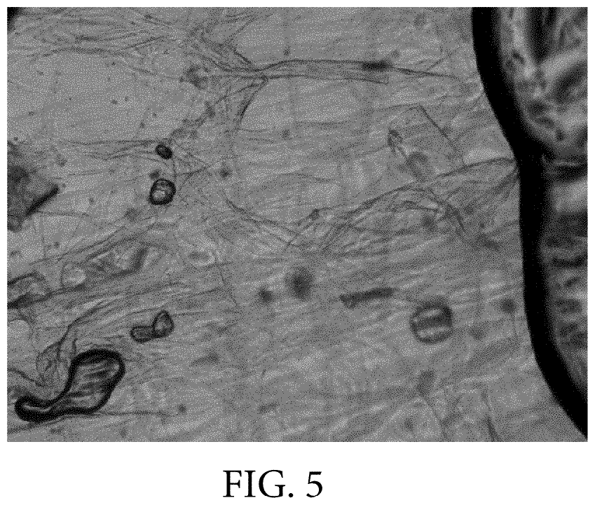

FIG. 3 shows a photographic view through an optical microscope of a specimen that was placed on a microscope slide and covered with a glass coverslip without the use of a mounting medium. FIG. 4 shows a photographic view of a specimen that was mounted on a microscope slide using the first mixture and cover slip. FIG. 5 shows a photographic view of a specimen that was mounted on a microscope slide using the second mixture and a glass coverslip. A comparison of FIGS. 3 and 4 shows the beneficial effects of using the first mixture because the details of the specimen in FIG. 4 are more clearly visible than the details of the specimen in FIG. 3. Similarly, a comparison of FIGS. 3 and 5 shows the beneficial effects of using the second mixture because the details of the specimen in FIG. 5 are drastically more visible than the details of the specimen in FIG. 3. Finally, a comparison of FIGS. 4 and 5 shows the beneficial effects of the second mixture relative to the first one because the details of the specimen in FIG. 5 are clearly more visible than the details of the specimen in FIG. 4.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A mounting medium comprising:
a mixture of:
anhydrous chloral;
Eucalyptol;
camphor; and,
a resin.

2. The mounting medium of claim 1 further comprising:
anhydrous chloral in a concentration of twenty-five to forty-seven percent (25-47%) by weight;
Eucalyptol in concentrations between thirty and fifty percent (30-50%) by weight;
camphor in concentrations between twenty and twenty-one percent (20-21%) by weight; and,
wherein the resin is sandarac or gum Arabic or copal in a concentration of up to five percent (5%) by weight.

3. The mounting medium of claim 2 prepared by mixing together thirty (30) grams of eucalyptol, twenty-five (25) grams of anhydrous chloral, twenty (20) grams of camphor and five (5) grams of sandarac.

4. The mounting medium of claim 2 prepared by mixing together thirty-two (32) grams of eucalyptol, forty-seven (47) grams of anhydrous chloral, and twenty-one (21) grams of camphor.

5. The mounting medium of claim 2 prepared by mixing together forty (40) grams of eucalyptol, thirty-five (35) grams of anhydrous chloral, twenty (20) grams of camphor and five (5) grams of sandarac.

6. A method of mounting a specimen to a microscope slide comprising the steps of:
preparing a liquid mixture by mixing together eucalyptol, anhydrous chloral, camphor and sandarac;
placing a thin section of a biological specimen on a microscope slide;
covering the specimen with the liquid mixture;
heating the microscope slide, specimen, and liquid mixture to a temperature of about seventy degrees centigrade (70° C., 158° F.);
maintaining the temperature for twenty (20) minutes, after which time the microscope slide, specimen, liquid mixture, and cover glass together are removed from the heat source and allowed to cool.

7. The method of claim 6 further comprising the steps of:
preparing the liquid mixture by mixing together thirty (30) grams of eucalyptol, twenty-five (25) grams of anhydrous chloral, twenty (20) grams of camphor and five (5) grams of sandarac.
